(19) United States
(12) Patent Application Publication
(10) Pub. No.: US 2009/0093207 A1
(43) Pub. Date: Apr. 9, 2009

(54) Door for air conditioner in vehicle

(76) Inventors: Seongseok Han, Daejeon-si (KR); Sangkyu Park, Daejeon-si (KR)

Correspondence Address: FULBRIGHT & JAWORSKI, LLP, 666 FIFTH AVE, NEW YORK, NY, 10103-3198, US

(21) Appl. No.: 12/286,963

(22) Filed: Oct. 3, 2008

(30) Foreign Application Priority Data
Oct. 9, 2007 (KR) 2007-101562
Sep. 30, 2008 (KR) 2008-95820

(51) Int. Cl. B60H 1/32

(52) U.S. Cl. 454/155

(57) ABSTRACT

The present invention relates to a door for an air conditioner in a vehicle, which includes a sheet member adapted to surround a door body, joining means for fixing both end portions of the sheet member to the door body, and support portions protrudingly formed on sides of the door body to form sheet member buffering spaces, thereby reducing material expenses and the entire manufacturing costs by reducing weight of the door, preventing a bad smell generated by inhabitation of molds by using the sheet member, preventing noise generated when the door is operated, and easily fixing the sheet member through a simple structure.

### BACKGROUND OF THE INVENTION

1. Field of the Invention

The present invention relates to a door for an air conditioner in a vehicle, and more particularly, to a door for an air conditioner in a vehicle, which includes a sheet member adapted to surround a door body, joining means for fixing both end portions of the sheet member to the door body, and support portions protrudingly formed on sides of the door body to form sheet member buffering spaces, thereby reducing material expenses and the entire manufacturing costs by reducing weight of the door, preventing a bad smell generated by inhabitation of molds by using the sheet member, preventing noise generated when the door is operated, and easily fixing the sheet member through a simple structure.

2. Background Art

In general, an air conditioner for vehicles is a car interior component, which is installed in the vehicle for the purpose of cooling the inside of the vehicle in the summer season or the winter season or removing frost from a windshield in rainy season or winter season to thereby secure a driver's front and rear visual field. Since such an air conditioner typically includes a heating device and a cooling device together, so that it heats, cools or ventilates the inside of the vehicle through the steps of selectively introducing the indoor air or the outdoor air to the air conditioner through a blower unit, heating or cooling the introduced air, and blowing the heated or cooled air into the vehicle.

Such an air conditioner is classified into a three-piece type where a blower unit, an evaporator unit, and a heater core unit are disposed independently, a semi-center type where the evaporator unit and the heater core unit are embedded in an air-conditioning case and the blower unit is mounted separately, and a center-mounting type where the three units are all embedded in the air-conditioning case.

FIG. 1 illustrates the semi-center type air conditioner. In FIG. 1, the air conditioner 1 includes: an air-conditioning case 10 having an air inflow port 11 formed on an inlet thereof and a defrost vent 12a, a face vent 12b and floor vents 12c and 12d mounted on an outlet thereof in such a way as to be adjusted in a degree of opening by mode doors 16; a blower (not shown) connected to the air inflow port 11 of the air-conditioning case 10 for sending inside air or outside air; an evaporator 2 and a heater core 3 embedded in the air-conditioning case 10; and a temperature-adjusting door 15 mounted between the evaporator 2 and the heater core 3 for adjusting opened amounts of a cold air passageway P1 bypassing the heater core 3 and a warm air channel flow P2 passing through the heater core 3.

Furthermore, the floor vents 12c and 12d are divided into a floor vent 12c for a front seat and a floor vent 12d for a rear seat.

Moreover, the temperature-adjusting door 15 and a mode door 16 respectively include rotary shafts 15b and 16b rotatably mounted on both side walls of the air-conditioning case 10 and plates 15a and 16a formed at one side of the rotary shafts 15b and 16b. In this instance, as the mode door 16, a center pivot door having the plates 16a formed at both sides of the rotary shaft 16b may be used.

The temperature-adjusting door 15 and the mode door 16 are connected to a cam (not shown) or a lever (not shown), which is actuated by an actuator (not shown) mounted on an outer surface of the air-conditioning case 10, and rotatably operated to thereby adjust the opened amounts of the cold and warm air passageways P1 and P2 or adjust an opened amount of a passageway directing the vents 12a to 12d.

In addition, as shown in FIG. 2, the temperature-adjusting door 15 and the mode door 16 further include sealing members 15c and 16c attached to the edges of the plates 15a and 16a. The sealing members 15c and 16c are in close contact with a wall surface of the air-conditioning case 10 to improve sealability when the doors 15 and 16 close the corresponding passageways.

In the air conditioner 1 having the above structure, in case of the greatest cooling mode, the temperature-adjusting door 15 opens the cold air passageway P1 and closes the warm air passageway P2. Accordingly, the air blown by a blower (not shown) is converted into cold air by heat-exchanging with refrigerant flowing inside the evaporator 2 while passing through the evaporator 2, and then, flows toward a mixing chamber (MC) through the cold air passageway P1. After that, the converted air is discharged to the inside of a vehicle through the vents 12a to 12d opened according to a predetermined air-conditioning mode, whereby the inside of the vehicle is cooled.

Moreover, in case of the greatest heating mode, the temperature-adjusting door 15 closes the cold air passageway P1 and opens the warm air passageway P2. Accordingly, the air blown by a blower (not shown) passes through the evaporator 2, is converted into warm air by heat-exchanging with cooling water flowing inside the heater core 3 while passing through the heater core 3 through the warm air passageway P2, and then, flows toward the mixing chamber (MC). After that, the converted air is discharged to the inside of a vehicle through the vents 12a to 12d opened according to the predetermined air-conditioning mode, whereby the inside of the vehicle is heated.

In the meantime, in case of a half cooling mode, the temperature-adjusting door 15 is rotated to a neutral position, and opens the cold air passageway P1 and the warm air passageway P2 relative to the mixing chamber (MC). Accordingly, the cold air passing through the evaporator 2 and the warm air passing through the heater core 3 flow toward the mixing chamber (MC) and are mixed with each other, and then, are discharged to the inside of the vehicle through the vents 12a to 12d opened according to the predetermined air-conditioning mode.

The temperature-adjusting door 15 and the mode door 16 respectively have the sealing members 15c and 16c to increase sealability, but have a problem in that they generate a bad smell because of inhabitation of molds on the sealing members 15c and 16c.

Furthermore, since the sealing members 15c and 16c mounted on the temperature-adjusting door 15 and the mode door 16 are is very expensive and require much time to mount them to the temperature-adjusting door 15 and the mode door 16, the manufacturing price is increased.

Moreover, since the plates 15a and 16a of the doors 15 and 16 have a predetermined thickness to allow mounting of the sealing member 15c and 16c, the doors 15 and 16 are very heavy and need great material costs by weight.

In the meantime, as another prior art, in order to enhance the sealing performance, a seal member made of a rubber material may be integrally molded on an edge of the door plate when the door is injection-molded. However, if the seal member made of the rubber material is injection-molded, it causes a problem in that adhesive sound (sound generated when rubber adhered on the surface of a case is separated from the surface) while the rubber material, which is in close contact with the projection (sealing surface) of the case, is separated from the contact surface.

### SUMMARY OF THE INVENTION

Accordingly, the present invention has been made to solve the above-mentioned problems occurring in the prior arts, and it is an object of the present invention to provide a door for an air conditioner in a vehicle, which includes a sheet member adapted to surround a door body, joining means for fixing both end portions of the sheet member to the door body, and support portions protrudingly formed on sides of the door body to form sheet member buffering spaces, thereby reducing material expenses and the entire manufacturing costs by reducing weight of the door, preventing a bad smell generated by inhabitation of molds by using the sheet member, preventing noise generated when the door is operated, and easily fixing the sheet member through a simple structure.

To accomplish the above object, according to the present invention, there is provided a door for an air conditioner in a vehicle, which is rotatably mounted inside an air-conditioning case to thereby adjust a degree of opening of a specific passageway inside the air-conditioning case, the door comprising: a rotary shaft rotatably mounted inside the air-conditioning case; a door body operated together with the rotary shaft to adjust the degree of opening of the specific passageway; a sheet member mounted in such a way as to surround the door body, the sheet member being in close contact with projections formed inside the air-conditioning case; and support portions protrudingly formed on sides of the door body to support the sheet member, the support portions forming sheet member buffering spaces on the sides of the door body corresponding to the projections of the air-conditioning case.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view of an air conditioner for a vehicle according to a prior art;

FIG. 2 is a perspective view of a temperature-adjusting door of FIG. 1;

FIG. 3 is a sectional view of an air conditioner for a vehicle, to which a door according to the present invention is applied;

FIG. 4 is a perspective view of the door according to the present invention;

FIG. 5 is an exploded perspective view of the door according to the present invention;

FIG. 6 is a sectional view taken along the line of A-A of FIG. 4;

FIG. 7 is a sectional view showing a case where the door according to the present invention is constructed in such a way that only one side of the door is sealed;

FIG. 8 is a sectional view showing a state where a door body of the door according to the present invention does not include through holes;

FIGS. 9 and 10 are sectional views showing modifications of joining means of the door according to the present invention;

FIG. 11 is a partially sectional view showing a state where the door according to the present invention closes passageways formed inside an air-conditioning case; and

FIGS. 12 and 13 are views showing a process that a sheet member is assembled to the door body of the door according to the present invention.

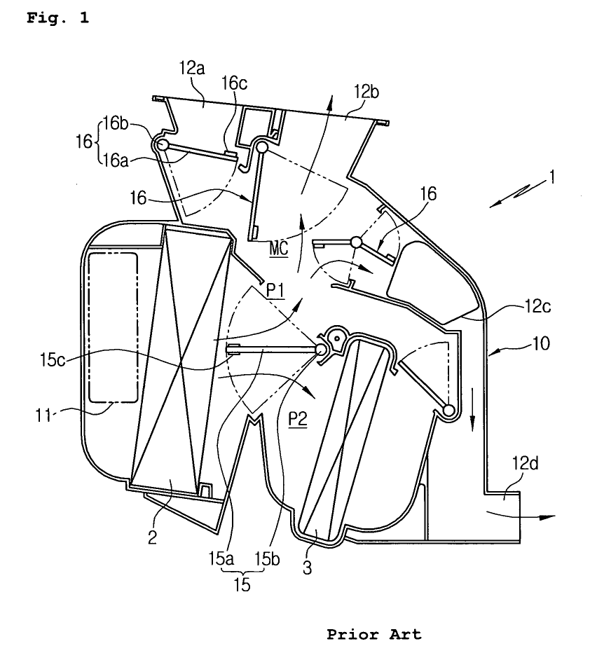

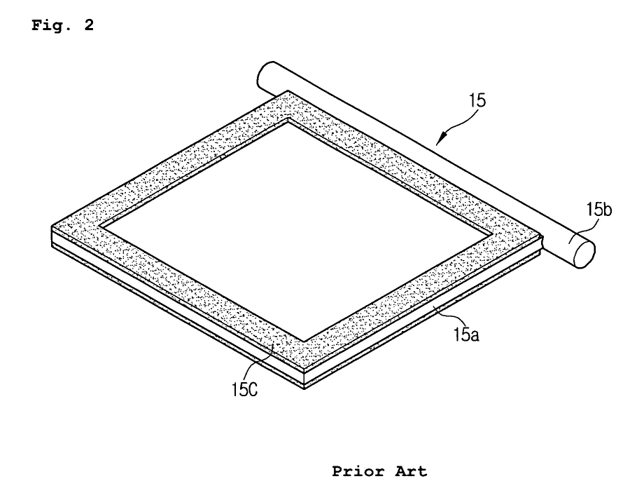

### DETAILED DESCRIPTION OF THE PREFERRED EMBODIMENT

Reference will be now made in detail to the preferred embodiment of the present invention with reference to the attached drawings.

The same parts as the prior art have the same reference numerals as the prior art.

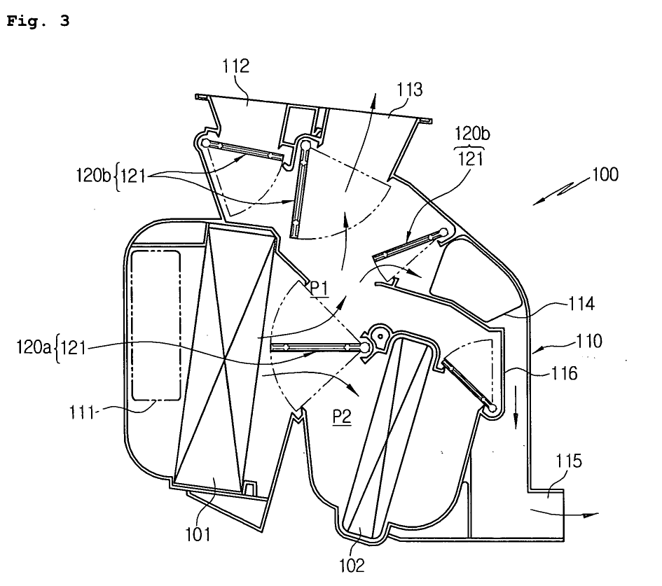

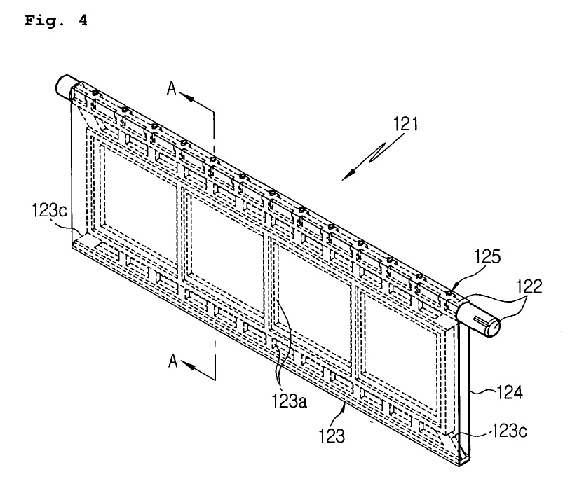

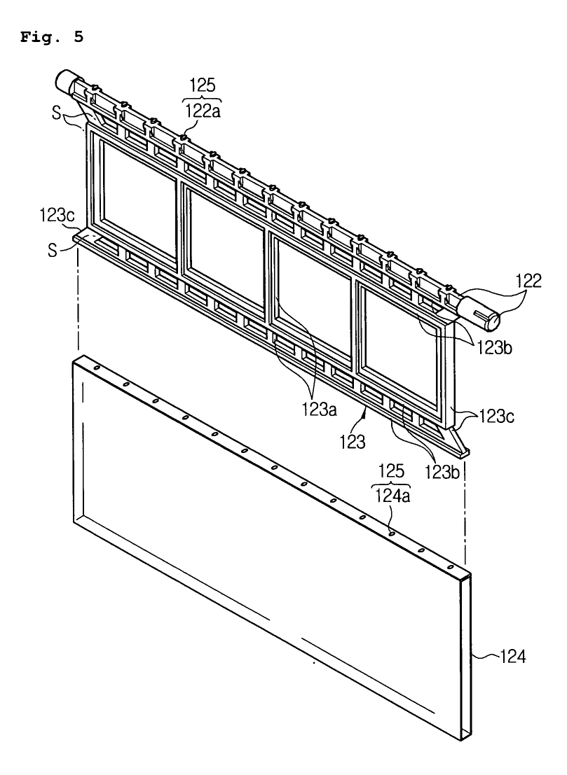

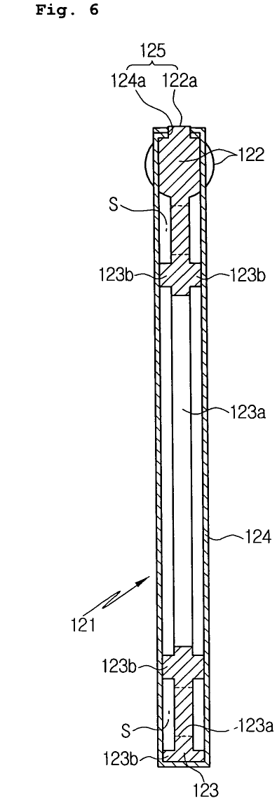

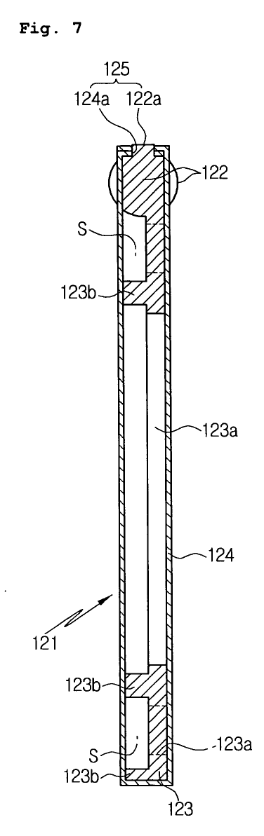

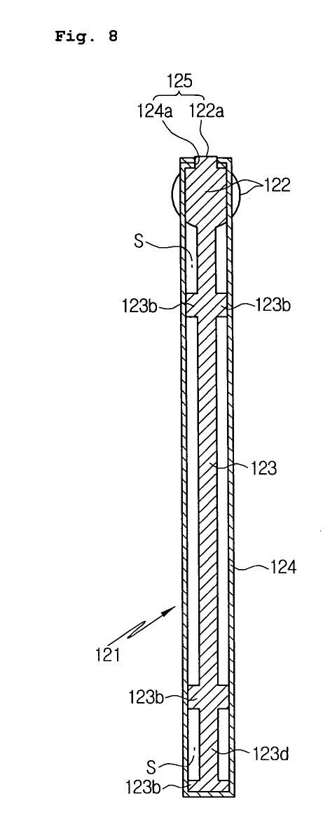

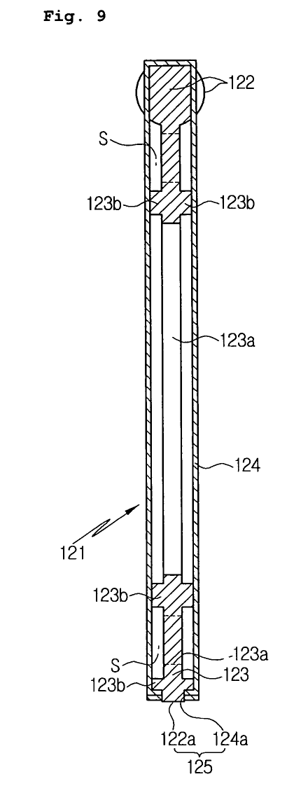

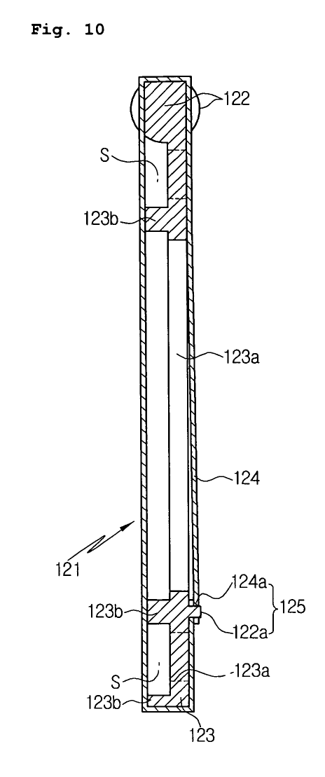

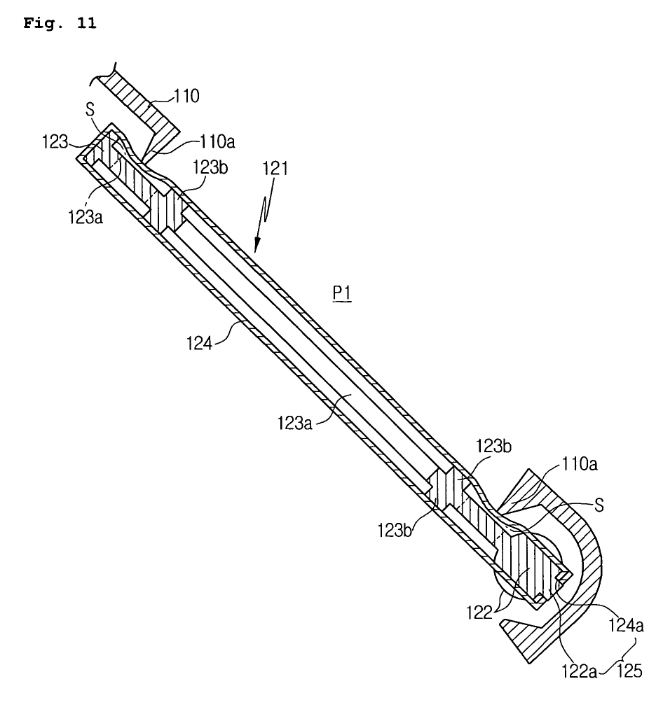

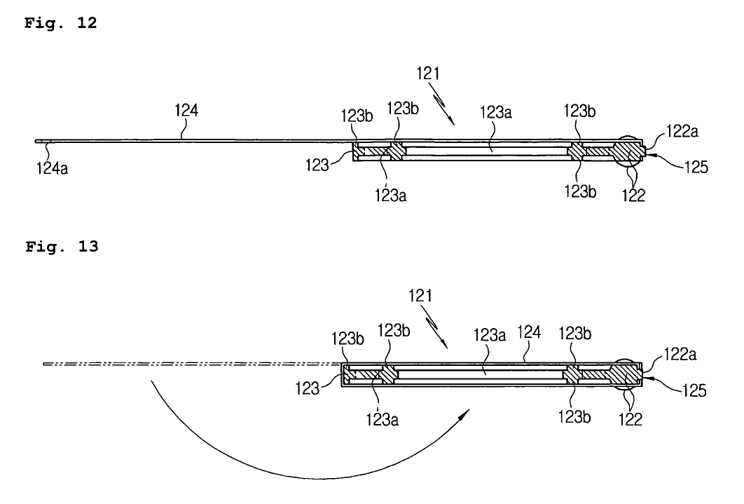

FIG. 3 is a sectional view of an air conditioner for a vehicle, to which a door according to the present invention is applied, FIG. 4 is a perspective view of the door according to the present invention, FIG. 5 is an exploded perspective view of the door according to the present invention, FIG. 6 is a sectional view taken along the line of A-A of FIG. 4, FIG. 7 is a sectional view showing a case where the door according to the present invention is constructed in such a way that only one side of the door is sealed, FIG. 8 is a sectional view showing a state where a door body of the door according to the present invention does not include through holes, FIGS. 9 and 10 are sectional views showing modifications of joining means of the door according to the present invention, FIG. 11 is a partially sectional view showing a state where the door according to the present invention closes passageways formed inside an air-conditioning case, and FIGS. 12 and 13 are views showing a process that a sheet member is assembled to the door body of the door according to the present invention.

First, the door 121 for an air conditioner of a vehicle according to the present invention is applicable to various air conditioners of a center-mounting type, a semi-center type, a three-piece type, and so on. In the present invention, as an example, a semi-center type air conditioner 100 will be described.

The semi-center type air conditioner 100 will be described in brief. The semi-center type air conditioner 100 includes: an air-conditioning case 110 having an air inflow port 111 formed on an inlet thereof, a plurality of air outflow ports formed on an outlet thereof, and a cold air passageway P1 and a warm air passageway P2 formed on an inner passageway thereof; and an evaporator 101 and a heater core 102 mounted on the inner passageway of the air-conditioning case 110.

Furthermore, a blower (not shown) is mounted on the air inflow port 111 of the air-conditioning case 110 for selectively introducing the inside air or the outside air through an inside air inflow hole (not shown) and an outside air inflow hole (not shown) opened and closed by an inside and outside air converting door (not shown).

In addition, the plurality of air outflow ports formed on the outlet of the air-conditioning case 110 are a defrost vent 112 for discharging air toward the front window of the vehicle, a face vent 113 for discharging air toward the face of a passenger, who seats on the front seat, and floor vents 114 and 115 for discharging air toward the passenger's feet.

The floor vents 114 and 115 are divided into the floor vent 114 for the front seat to discharge the air toward the front seat passenger's feet, and the floor vent 115 for the rear seat to discharge the air toward the rear seat passenger's feet.

In the meantime, a guide wall 116 is formed between the warm air passageway P2 of the rear of the heater core 102 and the floor vents 114 and 115 to divide them from each other.

Additionally, a plurality of doors 121 are mounted on the inner flow channel of the air-conditioning case 110 to adjust a degree of opening of specific passageways, namely, the cold air passageway P1, the warm air passageway P2, and passageways directing the vents 112 to 115.

Furthermore, the air-conditioning case 110 has projections 110a formed on the inner face thereof in such a way as to be in close contact with the doors 121 to thereby enhance sealability when the door 121 closes the specific passageway inside the air-conditioning case 110.

The doors 121 includes: a temperature-adjusting door 120a mounted between the evaporator 101 and the heater core 102 for adjusting the degree of opening of the cold air passageway P1 bypassing the heater core 102 and the warm air passageway P2 passing through the heater core 102; and mood doors 120b mounted on the upstream flow channel of each vent to adjust the degree of opening of the defrost vent 112, the face vent 113 and the floor vents 114 and 115.

In the meantime, the temperature-adjusting door 120a and the mood doors 120b are operationally rotated in a state where they are connected to a cam (not shown) or a lever (not shown) actuated by an actuator (not shown) mounted on an outer face of the air-conditioning case 110 to thereby adjust the degree of opening of the cold and warm air passageways P1 and P2 and the vents 112 to 115.

Hereinafter, the doors 121 will be described in more detail.

Each of the doors 121 includes: a rotary shaft 122 rotatably mounted on both inner side walls of the air-conditioning case 110; a door body 123 operated together with the rotary shaft 122 to thereby adjust the degree of opening of the passageways inside the air-conditioning case 110; and a sheet member 124 mounted in such a way as to surround the door body 123, the sheet member 124 being in close contact with the projections 110a formed inside the air-conditioning case 110.

The door body 123 is integrally formed on one side of the rotary shaft 122 in a mesh form having a plurality of through holes 123a to reduce weight of the door 121. That is, it is preferable that the door body 123 is constructed of the mesh form to support the sheet member 124 and minimize weight of the door since it is just a frame to mount the sheet member 124 thereon.

In this instance, even though the door body 123 is constructed of the mesh form having a plurality of the through holes 123a, since the sheet member 124, which wind does not ventilate, surrounds the side of the door body 123, wind cannot pass through the through holes 123a of the door body 123.

Here, it is preferable that the sheet member 124 is made of fabric, but may be a sheet film made of polyethylene or polypropylene, and may be made of one of various materials.

As described above, when the sheet member 124, which is made of a thin material, such as fabric or film, capable of being flexibly transformed, it can minimize inhabitation of molds, reduce manufacturing costs, and reduce noise generated when the door is actuated since the sheet member 124 is separated from the projections 110a of the air-conditioning case 110 without attachment after being in close contact with the projections 110a.

In the meantime, the sheet member 124 may contain an antibacterial material in order to prevent inhabitation of the molds and reduce a bad smell. That is, when the sheet member 124 is manufactured, the antibacterial material may be added or coated on the surface of the sheet member 124.

Furthermore, as shown in FIG. 11, while the projections 110a of the air-conditioning case 110, which are in contact with the sheet member 124 located at both width-directional end portions of the door body 123, project in such a way as to be in perpendicular contact with the sheet member 124, the projections 110a of the air-conditioning case 110 (not shown), which are in contact with the sheet member 124 located at both length-directional end portions of the door body 123, project on the inner face of the air-conditioning case 110 in such a way as to be in parallel face-to-face contact with the sheet member 124.

Of course, the structure of the projections 110a may be changed in various ways according to a design purpose.

Moreover, the door body 123 includes support portions 123b protrudingly formed on sides of the door body 123 to support the sheet member 124, the support portions 123b having sheet member buffering spaces (S) formed on the sides of the door body 123 corresponding to the projections 110a of the air-conditioning case 110.

The support portions 123b are formed along a circumference of some areas of the sheet member 124, which is in close contact with the projections 110a of the air-conditioning case 110, in such a way that the areas of the sheet member 124 are drawn into the buffering spaces (S). That is, the support portions 123b are formed along circumferential end portions of the door body 123, and accordingly, the sheet member buffering spaces (S) of a predetermined width are formed on side edges of the door body 123 by the support portion 123b.

Additionally, as shown in FIG. 11, the support portions 123b are formed in such a way as to support the both drawn portions of the sheet member 124, which are drawn into the buffering spaces (S). That is, at the both width-directional end portions of the door body 123, the support portions 123b are formed adjacently to both sides of end portions of the projections 111a to thereby support both sides of the drawn portion of the sheet member 124, so that it can minimize an excessive transformation of the sheet member 124, for instance, drooping of the sheet member 124.

Furthermore, a size of the buffering space (S) can be easily adjusted through a projection height of the support portions 123b.

In the meantime, at both width-directional end portions of the door body 123, the support portions 123b are respectively formed on both sides of the buffering spaces (S) to respectively support both sides of the drawn portion of the sheet member 124. However, at both length-directional end portions of the door body 123, the support portions 123b are respectively formed only on one side of the buffering space (S) to thereby support only one side of the sheet member 124 drawn into the buffering space (S). Accordingly, one end portion of the sheet member 124 located at both length-direction end portions of the door body 123 is not supported by the support portions 123b.

That is, since the projection 110a of the air-conditioning case 110 being in close contact with the sheet member 124 located at both length-directional end portions of the door body 123 is protrudingly formed in such a way as to be in parallel face-to-face contact with the sheet member 124, when the support portions 123b supporting the end portions of the sheet member 124 are omitted, it can prevent a collision noise generated when the sheet member 124 is in face-to-face contact with one side of the projection 110a.

If the support portions 123b are formed on both length-direction end portions of the door body 123 in such a way as to respectively support both sides of the drawn portion of the sheet member 124, namely, in such a way as to support also the end portion of the sheet member 124, the support portions 123b are in close contact with the one side of the projection 110a of the air-conditioning case 110 and it causes the collision noise.

In the meantime, it is preferable that recesses 123c are inwardly formed on both length-directional end portions of the door body 123 to prevent a collision with the projections 110a of the air-conditioning case 110 by omitting the support portions 123b supporting the end portions of the sheet member 124.

Moreover, in the drawings, it is illustrated only that the recesses 123c are formed on the length-directional end portions of the door body 123, but it is possible that the support portions 123b are also formed on both sides of the buffering space (S) like the width-directional end portions of the door body 123 without forming the recesses 123c according to a structure of the projections 110a of the air-conditioning case 110.

In the meantime, the support portions 123b are formed along the circumference of the buffering spaces (S), and also formed between the through holes 123a formed on the door body 123 to support the sheet member 124.

Furthermore, in case where each of the doors 121 is constructed in such a way as to be sealed at both sides thereof, the support portions 123b are respectively formed on both sides of the door body 123 to thereby form the buffering spaces (S) at both sides of the door body 123. However, in case where each of the doors 121 is constructed in such a way as to be sealed only at one side thereof as shown in FIG. 7, the support portions 123b are formed only on one side of the door body 123, so that the buffering spaces (S) are formed only on one side of the door body 123.

Additionally, the door body 123 may include a plurality of the through holes 123a or may not include the through holes 123a as shown in FIG. 8. That is, rigidity of the door 121 can be enhanced when the door body 123 is constructed of a thin plate member without the through holes 123a.

In addition, the door body 123 further includes a stopper 123d formed between the support portions 123b respectively supporting both sides of the drawn portion of the sheet member 124 to thereby prevent an excessive transformation of the sheet member 124. That is, the stopper 123d is mounted in such a way as to be opposed to the sheet member 124 drawn into the buffering space (S), so that the stopper 123d prevents the excessive transformation of the sheet member 124 when the sheet member 124 is transformed to a predetermined extent.

In the meantime, the buffering spaces (S) formed on sides of the door body 123 through the support portions 123b may be formed not only at the end portions of the door body 123 but also at various locations of the door body 123 according to a structure of the air-conditioning case 110, and the number and the form of the buffering spaces (S) may be varied.

Moreover, both end portions of the sheet member 124 surrounding the door body 123 is joined to the door body 123 through joining means 125.

As shown in FIG. 6, the joining means 125 includes fixing pins 122a protrudingly formed on one side of the rotary shaft 122 and holes 124a formed at both end portions of the sheet member 124 in such a way as to be caught to the fixing pins 122a. The holes 124a of the sheet member 124 are caught to the fixing pins 122a, and then, the fixing pins 122a are fused.

A plurality of the fixing pins 122a are protrudingly formed on the rotary shaft 122, which is opposed to the door body 123, and are spaced apart from one another at predetermined intervals in a longitudinal direction of the rotary shaft 122. The holes 124a are formed at locations corresponding to the fixing pins 122a.

Accordingly, in a state where the holes 124a formed on one end portion of the sheet member 124 are caught to the fixing pins 122a of the rotary shaft 122, after the sheet member 124 surrounds the door body 123 while being tightly pulled, the holes 124a formed on the other end portion of the sheet member 124 are caught and fixed to the fixing pins 122a of the rotary shaft 122.

After that, the fixing pins 122a of the rotary shaft 122 are fused to thereby prevent a separation of the sheet member 124 from the door body 123.

Furthermore, as a modification of the joining means 125, as shown in FIGS. 9 and 10, the joining means 125 includes fixing pins 122a protrudingly formed on the door body 123 and holes 124a formed at both end portions of the sheet member 124 in such a way as to be caught to the fixing pins 122a. The holes 124a of the sheet member 124 are caught to the fixing pins 122a, and then, the fixing pins 122a are fused.

Here, while the fixing pins 122a of the joining means 125 shown in FIG. 9 are formed on the end portions of the door body 123, the fixing pins 122a of the joining means 125 shown in FIG. 10 are formed on a face of the door body 123, which does not need sealing.

That is, in case where the fixing pins 122a are formed on the door body 123, the fixing pins 122a are formed in such a way as to be spaced apart from the projections 110a or the support portions 123b at predetermined intervals, whereby an interference does not occur when the sheet member 124 is in contact with the projections 110a of the air-conditioning case 110.

In the meantime, the fixing pins 122a may be formed not only at the above-mentioned locations but also at various locations, where there is no interference between the fixing pins 122a and the projections 110a.

Hereinafter, an operation of the door 121 for the air conditioner in the vehicle accordingly to the present invention will be described.

First, an assembling process of the sheet member 124 will be described. In a state where the holes 124a formed on one end portion of the sheet member 124 are caught to the fixing pins 122a, after the sheet member 124 surrounds the door body 123 while being tightly pulled, the holes 124a formed on the other end portion of the sheet member 124 are caught and fixed to the fixing pins 122a, and then, the fixing pins 122a are fused to thereby finish assembly of the sheet member 124.

After the sheet member 124 is perfectly assembled, the door 121 is mounted to adjust the degree of opening of the specific passageway inside the air-conditioning case 110, namely, the door 121 serves as the temperature-adjusting door 120a, the mode door 120b or the inside and outside air converting door.

Hereinafter, an air circulation process inside the air-conditioning case 110 by the operation of the door 121 will be described.

First, the air blown by the blower (not shown) is converted into cold air while passing through the evaporator 101.

The cold air cooled while passing through the evaporator 101 is converted into warm air while bypassing the heater core 102 through the cold air passageway P1 according to the adjusted degree of opening of the cold and warm air passageways P1 and P2 of the temperature-adjusting door 120a or passing through the heater core 102 through the warm air passageway P2.

Continuously, the cold air or warm air selectively passing the cold air passageway P1 and the warm air passageway P2 is supplied to the inside of the vehicle through the vents 112 to 115, which are adjusted in the degree of opening by the mode door 120b, according to an air-conditioning mode to thereby cool or heat the inside of the vehicle.

Furthermore, when the temperature-adjusting door 120a closes the cold air passageway P1 or the warm air passageway P2 or when the mode door 120b closes the passageways directing the vents 112 to 115, the sheet member 124 surrounding the door body 123 is in close contact with the projections 110a formed on the air-conditioning case 110 to thereby provide good sealability.

That is, when the sheet member 124 is in close contact with the projections 110a of the air-conditioning case 110, some areas of the sheet member 124, which is in close contact with the projections 110a, are flexibly transformed and drawn into the buffering spaces (S), whereby sealability between the sheet member 124 and the projections 110a is enhanced and noise is prevented since shock generated when the sheet member 124 is in close contact with the projections 110a is absorbed.

As described above, the door 121 for the air conditioner in the vehicle according to the present invention is applicable to doors of all kinds including the temperature-adjusting door 120a, the mode door 120b, and the inside and outside air converting door.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A door for an air conditioner in a vehicle, which is rotatably mounted inside an air-conditioning case to thereby adjust a degree of opening of a specific passageway inside the air-conditioning case, the door comprising:
a rotary shaft rotatably mounted inside the air-conditioning case;
a door body operated together with the rotary shaft to adjust the degree of opening of the specific passageway;
a sheet member mounted in such a way as to surround the door body, the sheet member being in close contact with projections formed inside the air-conditioning case; and
support portions protrudingly formed on sides of the door body to support the sheet member, the support portions forming sheet member buffering spaces on the sides of the door body corresponding to the projections of the air-conditioning case.

2. The door according to claim 1, wherein the support portions are formed along a circumference of some areas of the sheet member, which is in close contact with the projections of the air-conditioning case, in such a way that the areas of the sheet member are drawn into the buffering spaces.

3. The door according to claim 2, wherein the support portions support both sides of the drawn portions of the sheet member, which are drawn into the buffering spaces.

4. The door according to claim 1, wherein recesses are inwardly formed on both length-directional end portions of the door body to thereby prevent a collision between the door body and the projections of the air-conditioning case.

5. The door according to claim 1, wherein the support portions are formed along circumferential end portions of the door body.

6. The door according to claim 1, wherein the support portions are formed on both sides of the door body.

7. The door according to claim 1, wherein the door body includes a stopper formed between the support portions respectively supporting the both sides of the drawn portion of the sheet member to thereby prevent an excessive transformation of the sheet member.

8. The door according to claim 3, wherein the projections are formed on the inner face of the air-conditioning case in such a way as to be in perpendicular contact with the sheet member.

9. The door according to claim 1, wherein the projections are formed on the inner face of the air-conditioning case in such a way as to be in parallel face-to-face contact with the sheet member.

10. The door according to claim 1, wherein the door body includes a plurality of through holes.

11. The door according to claim 1, wherein the sheet member is made of fabric or film.

12. The door according to claim 1, wherein the sheet member contains an antibacterial material.

13. A door for an air conditioner in a vehicle, which is rotatably mounted inside an air-conditioning case to thereby adjust a degree of opening of a specific passageway inside the air-conditioning case, the door comprising:
a rotary shaft rotatably mounted inside the air-conditioning case;
a door body operated together with the rotary shaft to adjust the degree of opening of the specific passageway; and
a sheet member mounted in such a way as to surround the door body, the sheet member being in close contact with projections formed inside the air-conditioning case, both end portions of the sheet member being joined to the door body through joining means.

14. The door according to claim 13, wherein the joining means includes: fixing pins protrudingly formed on one side of the rotary shaft; and holes formed at both end portions of the sheet member in such a way as to be caught to the fixing pins.

15. The door according to claim 13, wherein the joining means includes: fixing pins protrudingly formed on the door body; and holes formed at both end portions of the sheet member in such a way as to be caught to the fixing pins.

16. The door according to claim 14, wherein the fixing pins are fused in a state where the holes of the sheet member are caught to the fixing pins.

17. The door according to claim 15, wherein the fixing pins are fused in a state where the holes of the sheet member are caught to the fixing pins.

18. The door according to claim 15, wherein the fixing pins are formed at locations, which are spaced apart from the projections at a predetermined interval, to prevent an interference with the projections of the air-conditioning case.
